(19) United States
(12) Patent Application Publication
(10) Pub. No.: US 2005/0055270 A1
(43) Pub. Date: Mar. 10, 2005

(54) Supervisory control and acquisition system for retail advertising and reward program

(76) Inventor: Thomas Kenneth Broe, Calgary (CA)

Correspondence Address: John Russell Uren, P. Eng., Suite 202, 1590 Bellevue Avenue, West Vancouver, BC, V7V 1A7, CA

(21) Appl. No.: 10/656,562

(22) Filed: Sep. 4, 2003

(51) Int. Cl. G06F 17/60

(52) U.S. Cl. 705/14; 705/16

(57) ABSTRACT

A supervisory control system for a point of sale (POS) device or devices located within a business establishment. The point of sale (POS) devices are programmed to communicate with a master station (MS) located remotely from the point of sale (POS) device. Following approval of the usual credit or debit card transaction or if a cash transaction takes place, a reward may be generated by the point of sale (POS) device which encourages further business with the consumer either within the business establishment or within business establishments located remotely from the location of the business establishment where the point of sale (POS) device is initially used.

### INTRODUCTION

This invention relates to a supervisory control and acquisition system for a business establishment and, more particularly, to such a system particularly adapted for an advertising and customer reward system utilizing a programmable point of sale (POS) device which may be programmed remotely and which device is used for implementing the advertising and customer reward system.

### BACKGROUND OF THE INVENTION

Point of sale (POS) devices are ubiquitous in today's business world. POS devices are located at check out or cash register counters of countless businesses and serve to facilitate cashless business transactions. The merchant or the customer will swipe a credit or debit card through the POS device. The information encoded on the credit or debit card as well as the amount of the financial transaction is transmitted to a central switching processor which switching processor connects with the credit or debit card accounts of the customer and the business establishment. If funds are in place to cover the transaction, approval advice will be transmitted by the central switching processor to the POS device resulting in the transaction being finalized between the merchant and the customer. A printed receipt is usually issued to the customer from the POS device.

The utility of POS devices is necessarily limited. Financial and cashless transactions are the sole reason for their use. A broader mandate for the POS devices would be useful to justify the space such POS devices occupy at the business establishment, their universal use and the price of the technology supporting the POS device.

Reward programs for consumers are also well known. Coupons, vouchers, tickets and/or certificates are issued to customers in a variety of ways in an attempt to draw the customer to a business location or to otherwise purchase products or services. One reward issuing technique is to have an employee hand out a reward at the point of sale location. The employee handout of such rewards is subject to security concerns however and there is little if any tracking of the reward redemption process to determine the effectiveness of the reward program. It is further very difficult to determine the optimum number of rewards to be initially generated. An ability to obtain such information could reduce the costs of the reward system to the merchant and enhance its effectiveness to the consumer.

### SUMMARY OF THE INVENTION

According to the invention, there is provided a control and acquisition system for automated advertising of a first business establishment, said system comprising a master station (MS), a transaction processing switch (TPS), at least one point of sale (POS) device located at said business establishment and supervisory software allowing communication between said MS, said TPS and said POS device, said POS device generating a reward to a user interacting with said POS device.

According to a further aspect of the invention, there is provided a method of issuing a reward to a user participating in a financial transaction at a first business establishment and using a debit or credit card, said method including verifying information concerning said transaction and said debit or credit card, transferring funds between said account of said user and said business establishment using said debit or credit card and issuing said reward to said user following said verification of said information concerning said financial transaction and said debit or credit card.

According to yet a further aspect of the invention, there is provided a method of advertising using a point of sale(POS) processing device, said method comprising providing display and reward instructions to said processing device, allowing a user to provide information to said processing device in a financial transaction, obtaining financial information on said user to verify said financial transaction may be completed and issuing a reward to said user in accordance with said display and reward instructions.

According to yet a further aspect of the invention, there is provided a wireless card reader device to read personalized information of a user and means to issue a reward to said user following said reading of said information.

According to still yet a further aspect of the invention, there is provided a supervisory control and acquisition system for a first business establishment, said system comprising a programmable point of sale (POS) device located at said first business establishment, said programmable point of sale (POS) device being controlled by a processing unit communicating with said point of sale (POS) device from a location remote from said point of sale (POS) device, said programmable point of sale (POS) device being adapted to conduct credit and debit card transactions with a user and to provide a consumer with a reward at said first business establishment.

According to still yet a further aspect of the invention, there is provided a method of supervising an advertising and reward system carried out within a business establishment comprising the steps of programming at least one point of sale (POS) device located at a business establishment from a controller located remotely from said point of sale (POS) device, said programming containing instructions relating to said advertising and reward system, sensing a financial transaction occurring on said point of sale (POS) device with a consumer, determining whether said customer is eligible for receiving a reward and issuing said reward to said consumer if said consumer is eligible for said reward.

According to yet a further aspect of the invention, there is provided a supervisory control system for an automatic reward and advertising system intended for business establishments, said system comprising at least one point of sale (POS) card reader to read the card of a user and to dispense a reward to said user, a controller to program said point of sale (POS) device and to download data to and upload data from said point of sale (POS) device at predetermined intervals, said point of sale (POS) device generating a reward to said user wherein said user may redeem said reward at a business establishment having a location where said point of sale (POS) device is located.

### BRIEF DESCRIPTION OF THE SEVERAL VIEWS OF THE DRAWINGS

Specific embodiments of the invention will now be described, by way of example only, with the use of drawings in which:

FIG. 1 illustrates and is an overview of the control and acquisition system according to the invention wherein supervisory control is exercised over a plurality of POS devices located at different business establishments;

FIG. 2 illustrates a typical store chain with two sets of business establishments controlled by an entity in which the reward issuance and redemption according to the invention is shown in a variety of situations;

FIG. 3 illustrates a reward transaction given at a first business establishment which reward is intended to be redeemed at a second business establishment;

FIG. 4 is an overview of transactions that may occur between a plurality of POS devices located at independently owned, chain, multi-chain and franchised business establishments;

FIG. 5 is a series of tables that may be used to design supervisory software with different reward programs which may be downloaded to the various point of sale devices;

FIG. 6 illustrates typical downloads to and uploads from the POS device using the master station (MS):

FIG. 7 is an overview of the system according to the invention wherein a financial transaction between the consumer and the business establishment is shown which involves a credit card payment for goods or services;

FIG. 8 is an overview of the system according to the invention wherein a financial transaction between the consumer and the business establishment is shown which involves a debit card payment for goods or services; and

FIG. 9 illustrates a further embodiment of the invention wherein a reward is given to a consumer who participates in the financial transaction of FIG. 1 or 2.

### DESCRIPTION OF SPECIFIC EMBODIMENT

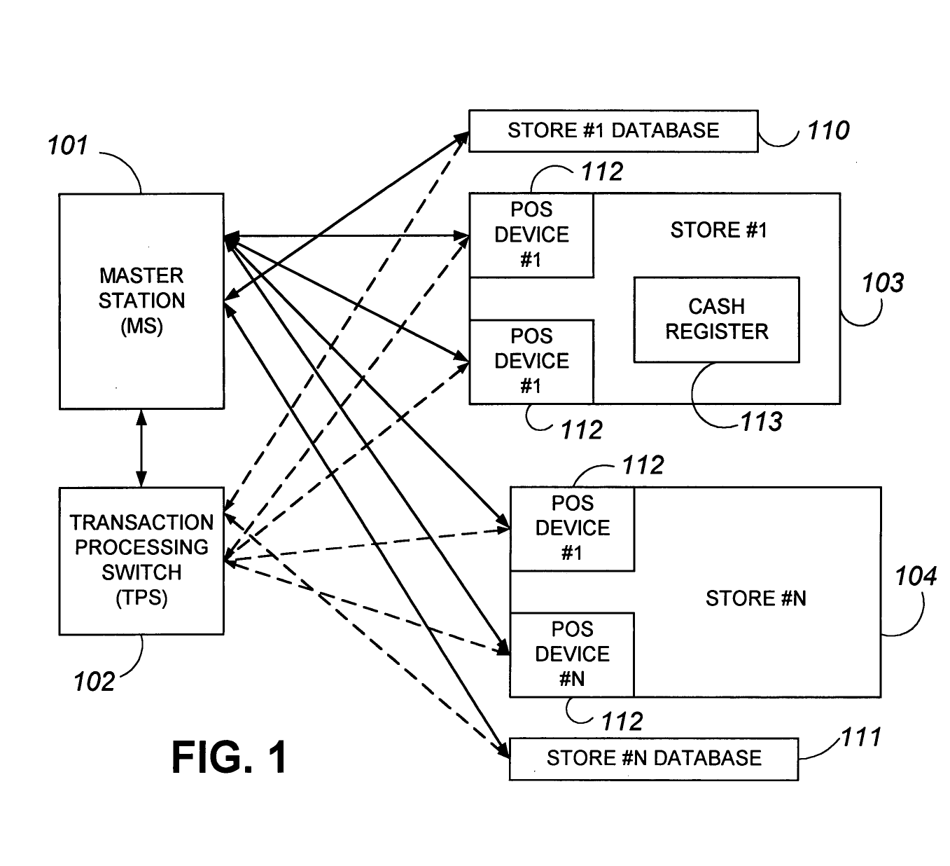

Referring now to the drawings, the supervisory, control and data acquisition system according to the invention is shown generally at 100 in FIG. 1. The system 100 includes a master station (MS) 101, a transaction processing switch (TPS) 102 and a plurality of point of sale devices 112 communicating with MS 101 and TPS 102. Two(2) business establishments 103, 104 are illustrated, it being understood that although only two(2) such establishments 103, 104 are conveniently shown, an additional number of establishments may be added without difficulty. Two databases 110, 111 are also shown, database 110 being the database applicable to the first business establishment 103 and database 111 being the data base applicable to the second business establishment 104.

TPS 102 is generally used to connect the various POS devices 112 with the financial accounts of the consumer, the business establishments 103, 104 and the accounts of the supervisory control system 100 in order to verify the financial transaction and to direct the funds into and out of the various accounts. TPS 102 carries a large number of communication channels to assist this function and conveniently also may be used to pass information from MS 101 to one or a plurality of POS devices 112.

MS 101 is generally used to administer a reward program for the consumer and to hold, transfer and receive data relating to this reward program. MS 101 has many fewer communication channels than TPS 102 as it required to communicate with POS 112 only at predetermined intervals. Both MS 101 and TPS 102 have the ability to communicate directly with the POS device 112. Generally, the TPS 102 will communicate for financial transaction purposes and MS 101 will communicate so as to receive information from and download information to the POS devices 112. MS 101 may request TPS 102 to pass information to the plurality of POS devices 112 and, likewise, TPS 102 may request MS 101 to pass information to the POS device 112.

Within each of the business establishments 103, 104, a number of POS devices 112, conveniently two(2) being shown in FIG. 1, together with an associated cash register 113 for business establishment 103.

Each POS device 112 interacts with MS 101 and TPS 102. MS 101 holds information which is communicated to each POS device 112 for the purpose of the reward or advertising function to a consumer during a financial transaction as will be explained. A financial transaction is defined as a usual debit or credit card purchase or as a cash purchase which may or may not include the reward as defined in greater detail below. The information communicated by MS 101 and TPS 102 includes the business programs intended to be implemented by each POS device 112 and how the retail programs are to be implemented by each POS device 112. The information, held within the MS 101 and/or TPS 102, is downloaded to each POS device 112 by direct communication although remote communication by phone line, wireless, satellite or cable communication may also be used. Similar downloading may also be implemented by TPS 102.

Each POS device 112 is programmed for several functions in addition to the usual functions of debit and credit card processing. The programming includes implementing a customer appreciation program, implementing a certificate program, implementing a voucher program, implementing a customer referral program and implementing a non-profit organization support program, all as will be explained in greater detail. Other functions may also conveniently be implemented and programmed into the POS device 112 by MS 101 from time to time, it being understood that the POS device 112 with its supervisory control system 100 is flexible and has the ability to receive and to implement an amended program without difficulty.

The POS device 112 is also programmed to offer application development systems which allow new applications to be generated and installed. The development systems are PC based and provide integrated tools to edit, compile, debug and download new applications to the POS device 112 from MS 101.

The POS device 112, in addition to emitting a sound or displaying news of a reward, conveniently also has enhanced printing capabilities so hard copy of the reward certificate may be generated. Likewise, the POS device 112 may be designed to copy the reward onto a SMART card or on to an RF identification card, as explained below.

A SMART card, carried by a user, has communication and memory ports and data may be written to and read from the card through the ports and not wirelessly. The card, therefore, is generally swiped through or inserted into a POS device 112 as is known.

An RF read/write identification card is a card carried by a user which has the ability to receive information from and transmit information to an appropriate and associated transmitting/receiving device wirelessly. In the present invention, the POS device 112 or a device associated therewith is intended to have the ability to receive information from and transmit information to the RF identification card.

In this application, the word “financial transaction” is intended to cover the situation where the POS device 112 executes any of the above-identified enumerated functions following approval receipt by the POS device 112 for a purchase made by the consumer or when there is a cash transaction involving a purchase. Information concerning each such financial transaction is stored in non-volatile memory of the POS device 112 until the information has been downloaded to MS 101. An acknowledgment of receipt of information is sent to the POS device 112 by MS 101 advising that the information has been downloaded. This then allows the POS device 112 to clear its memory. The memory required in the POS device 112 is therefore significantly smaller relative to the memory requirements of the MS 101.

The usual functions of debit and credit card processing are performed by the POS device 112 as mentioned. The POS device 112 will access a credit card processing network through the TPS 102 to obtain authorization for the charge. Likewise, the POS device 112 will access a debit card processing network through TPS 102 to obtain authorization for a debit card transaction as further explained below.

A customer appreciation program, as earlier enumerated, is one program intended to be covered with the POS device 112 together with the supervisory control network 100 which includes MS 101 and/or TPS 102. This program is designed to “reward” a customer who has made a purchase or purchases at the business establishments 103, 104 by the issuance of a redeemable voucher, coupon, ticket or certificate. When a financial transaction occurs as when it is initiated in the POS device 112, a random number generator, a counter or other mechanism of chance, will determine whether the consumer involved in the financial transaction is eligible for the reward. If the transaction is not eligible, the transaction will simply continue without notification of any reward to the consumer. If the transaction is eligible, the POS device 112 will emit a sound or show an appropriate display indicating that the transaction is a “winning” or eligible transaction and a reward may be expected or is given.

The reward which is offered to the customer participating in the financial transaction is, of course, conveniently determined by the business establishment by way of the aforementioned voucher, coupon, ticket or certificate. The voucher, coupon, ticket or certificate may offer merchandise at a reduced price for example or it may be the reward of actual goods as will be indicated on the voucher, coupon, ticket or certificate. The business establishment 103, 104 may determine whether the reward will be granted immediately or at a later date and whether the reward is redeemable in the business establishment where it was given or in another business establishment. Details of the reward are not important because they will change often but all aspects of what is offered and how it is offered will be conveniently dictated by the business establishment in which the POS device 112 is located to generate the reward or that business establishment where the reward is to be redeemed.

The “voucher program”, as earlier enumerated, is a program where customers may be directed to business units in the business establishment where a financial transaction occurs or to other business establishments jointly owned or associated with that business establishment. Alternatively, as the owner of the business establishment may decide, customers may conveniently be directed to independent business units not associated with the business establishment where the financial transaction takes place.

In either event, the POS device 112 will issue the voucher, coupon, ticket or certificate to the customer by way of hard copy or by way of downloading the reward information to a SMART card or an RF identification card as earlier described.

The POS device 112 may conveniently issue single or multiple rewards at the same time or the POS device 112 may allow the customer to select one or a number of rewards from a reward list provided to the customer by way of hard copy or display generated by the POS device 112. In any event, the POS device 112 will monitor the number of rewards issued, the identification numbers of the rewards and any other pertinent information required for the tracing of the reward which information, in due course, will be uploaded to MS 101 or TPS 102 and later downloaded to the potential redeeming POS devices 112 for validation of the reward, which is in the form of coupons, certificates, tickets, etc.

A “product certificate program”, as earlier described, allows the business establishment to sell products in other associated or non-associated business establishments. If the customer decides to purchase the product or products available through other outlets, the POS device 112 will collect the proper amount owed for each product and print a description of the product or products purchased. The product may be obtained by the customer directly or the product may be delivered, as the business establishment or the customer may decide. Again, the POS device 112 will maintain data on the products rewarded and the transfer of monies to the accounts of the other business establishments and to the supervisory control system 100. Uploading of data collected from the POS device 112 to the MS 101 or TPS 102 will take place at regular intervals as the supervisory control system 100 may determine usually at time of customer inactivity at the POS 112.

The “customer referral” program, as enumerated, is intended to direct “first time customers” to the business establishment. These first time customers are, of course, customers who have not yet frequented or made a purchase at the business establishment. In seeking to bring first time customers to the business establishment, the POS device 112 may conveniently issue a reward which is available not only to the consumer who is participating in the financial transaction but to a potential first time customer reached through the purchasing consumer. There may be an incentive for the purchasing consumer to bring a first time customer to the business establishment. And, as earlier explained, the reward need not be hard copy but instead could be downloaded to a SMART card or to an RF identification card. The POS device 112 will again conveniently store all information on the issuance and/or redeeming of the various rewards until the information is uploaded to MS 101.

The “non-profit organization support” program, as described, allows a customer participating in a financial transaction to make a monetary contribution to a non-profit organization or organizations which the business establishment wishes to support. A list of the organization or organizations may conveniently be displayed on the POS device 112 for viewing by the customer. When a transaction occurs, the customer is prompted by the POS device 112 to make a contribution to a non-profit organization listed and/or displayed on the POS device 112. The contributed amount will then be added to the amount of the transaction. The POS device 112 will print hard copy of the donation amount and an appropriate tax receipt which specifies the organization or organizations to which the money is directed. The POS device 112 will store information relating to the amounts and the organizations until the information is duly downloaded to the MS 101.

When a customer is participating in a financial transaction within a business establishment and the POS device 112 directs that customer to a further business unit within that business establishment or to a different business establishment, the customer's movement is called “migration” from the business establishment or business unit where the purchase occurred. Thus a business establishment may have various business units that sell, for example, sporting goods, clothing, appliances and the like, each of the departments being called a “business unit” within the business establishment and the customer may migrate between those business units according to this application.

A “store chain” is defined within this application as an organization that has a number of business establishments which may generally target the same market and which establishments are owned by a legal entity or which establishments are franchised by such an entity such that control of the store chain is by the entity, to a greater or lesser extent. The program is implemented from the POS 112 and MS 101 and is intended to encourage migration between business units within a business establishment or migration between different business establishments.

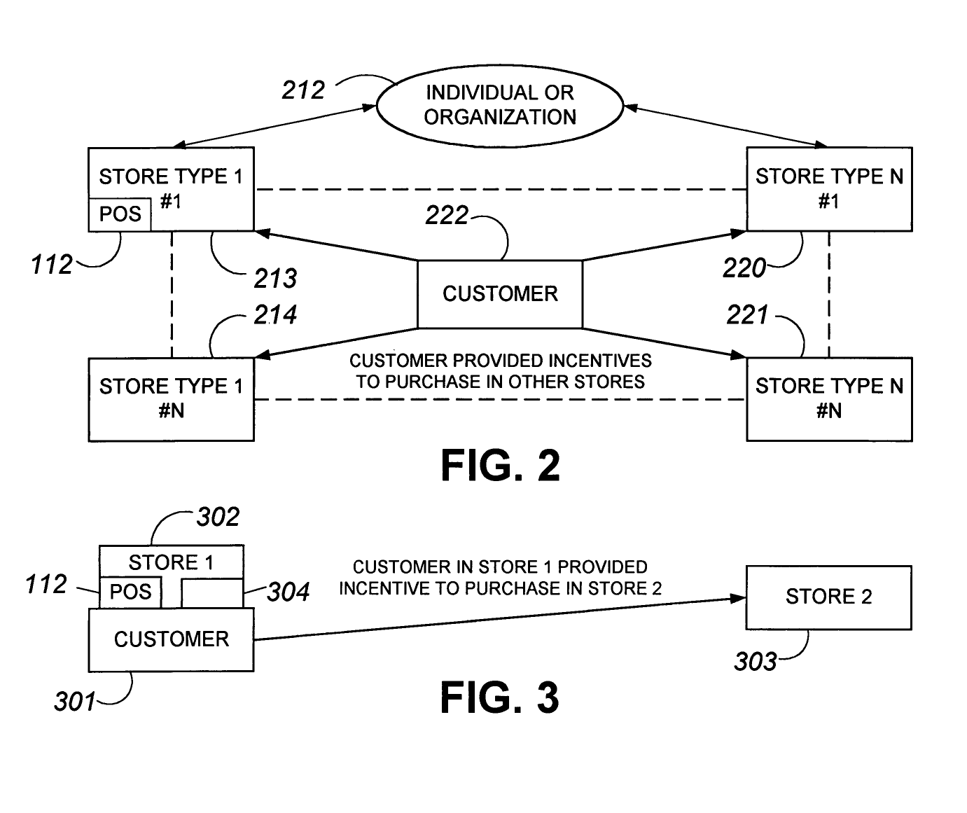

Reference is now made to FIG. 2 wherein the legal entity controlling the chain of stores is illustrated generally at 212. A vertical series of business establishments or stores selling similar goods or situated in similar locales is illustrated at 213, 214. A second vertical series of stores controlled by the same entity 212 is shown at 220, 221. The consumer 222, for example, could be given a reward by a POS device 112 in business establishment 213 which is redeemable only at store 220, thereby drawing him to other business establishments controlled by the entity 212.

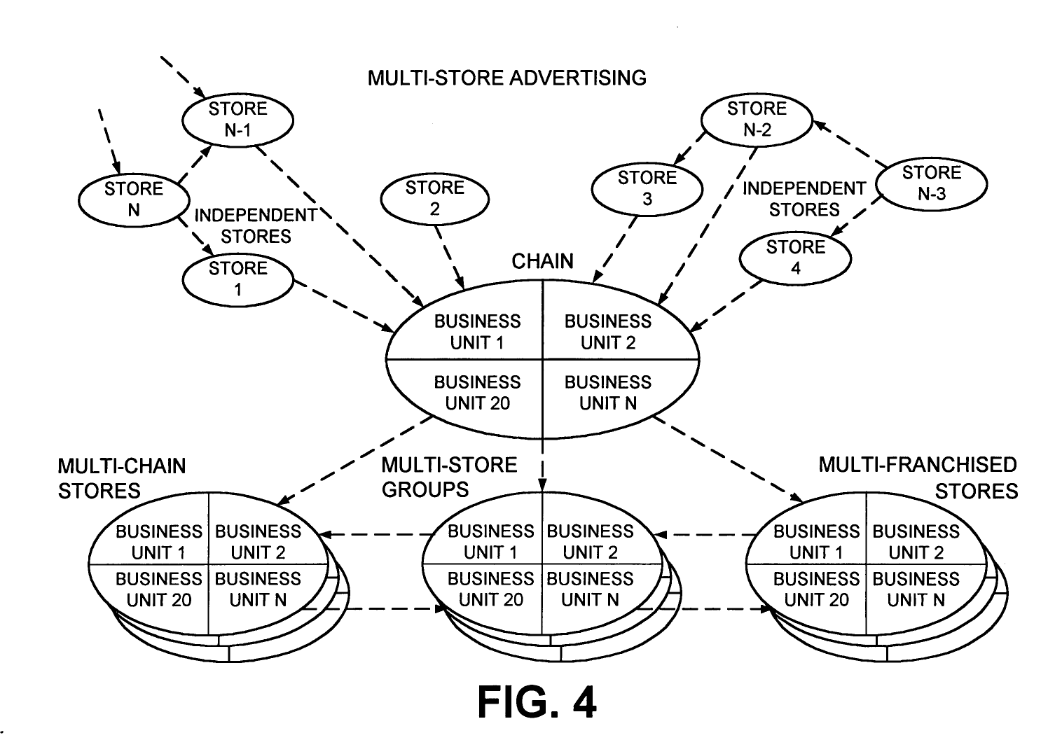

In a further embodiment of the invention, the consumer may be directed to a business establishment by a reward issued from an independent store or business establishment. Reference is made to FIG. 3 where a consumer 301 in business establishment 302 is given a reward 304 by way of voucher, coupon, ticket or certificate which is an incentive to purchase a product in a business establishment 303 which is independent from business establishment 302. The terms demanded by the independent business establishment 302 for such a program would lie between that merchant and the business establishment 303, for example, where the reward 304 is redeemed but it is contemplated that the POS device 112 and its supporting software as exemplified in supervisory control system 100 according to the invention may be attractive to certain business establishments because the POS device 112 can be programmed to provide debit and credit card processing at a reduced fee with a quicker turnaround of monies into the account of the business establishment than would be available under ordinary conditions. A payment could also be made directly to the independent business establishment 303 for issuing such rewards at its location. Reference is also made to FIG. 4 wherein cross-referrals between various business establishments are illustrated.

The POS device 112 (FIG. 1) inherently allows a consumer to purchase a product or service by using a debit or credit card or functions as well to issue a reward in a cash transaction. The POS device 112 conveniently interfaces with a cash register, a SMART card and/or an RF identification card and will include a handheld device to allow input of a personal identification number for the account of the purchaser if a debit card is utilized. A modem within the POS device 112 is used to dial a predetermined telephone number which connects the POS device 112 to an intelligent switch TPS 102 which has been programmed to allow banking transactions to be implemented by way of connections being made with financial institutions if a debit card is being used. The relevant financial institution responds with a positive or negative acknowledgment of the transaction and the result is communicated to the POS device 112 and is displayed. A receipt is duly printed. The transactions are performed using a communication protocol that is designed to handle banking transactions in a secure environment.

The reward distribution and redemption application, as earlier described, runs parallel to the existing debit or credit card capabilities of the POS device 112 as illustrated in FIG. 1. Redemption of any reward issued by a POS device 112 is confirmed by a printed report and/or appropriate downloading to a SMART and/or an RF identification card device.

The POS device 112 generates, prints and records details of the rewards given by way of coupons, vouchers, tickets or certificates. The POS device 112 generates, prints and records details of the rewards based on the daily dispensing rules and communicates that data directly or remotely to the MS 101 with the MS 101 administering the reward programs.

The POS device 112 is programmed to automatically display or, upon user request by way of a display interrogation scheme at the end of the financial transaction, to either print hard copy of the reward or, alternatively, to write the reward to a SMART or RF identification card. Appropriate programming of the POS device 112 by way of MS 101 controls the generation of rewards by the POS device 112 which programming can be altered by the supervisory control system 400 when desirable during a communication exchange with the POS device 112.

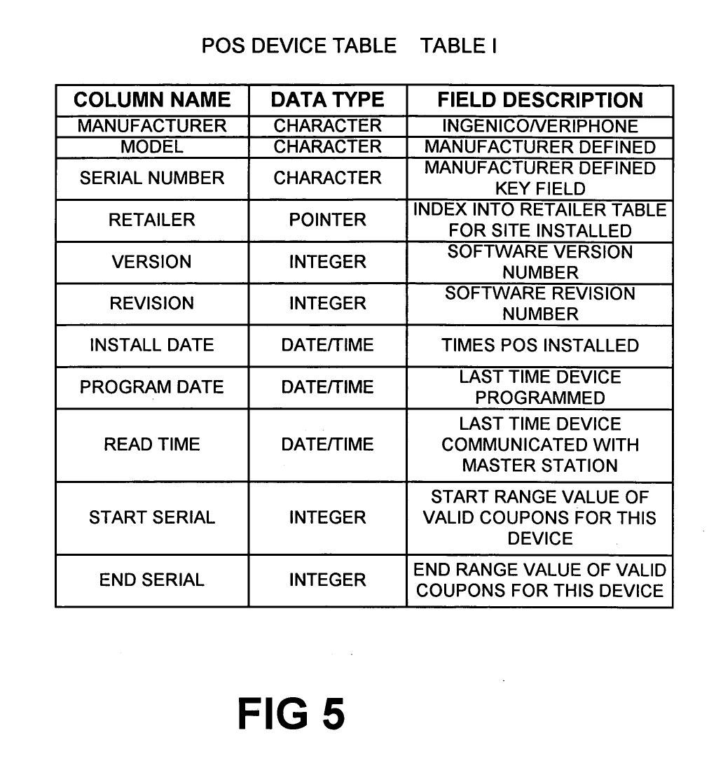

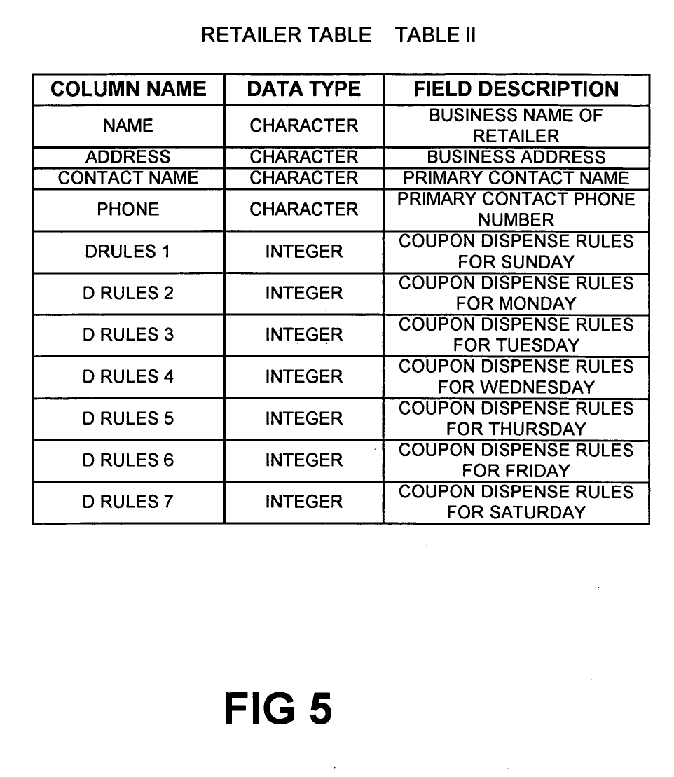

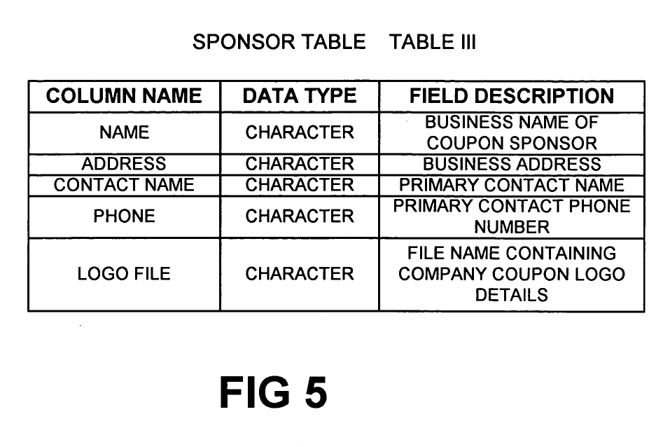

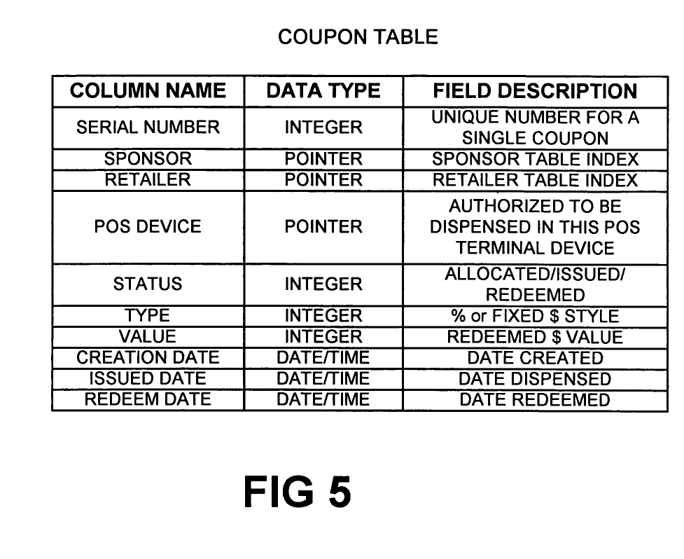

MS 101 administers the reward program and carries all data on the program when such data is uploaded from the POS device 112. The reward program is conveniently administered in a PC WINDOWS based environment. The program carries the relational database system which houses details of the reward system and which database includes a user interface to administer the reward program and to allow access to and entry of various fields in the database tables, the setup for such tables being conveniently seen in FIG. 5. Such information would include static information for the POS device 112, the number of rewards administered and any other data used to administer the reward program. Such information would further include a reporting interface to view/analyze the dispensed rewards with the interface allowing various queries to be performed on reward information in the database. Such queries would include the issued reward serial numbers for validation purposes and a file of redeemed rewards and their values so the redemption details in the reward database can be updated and reviewed.

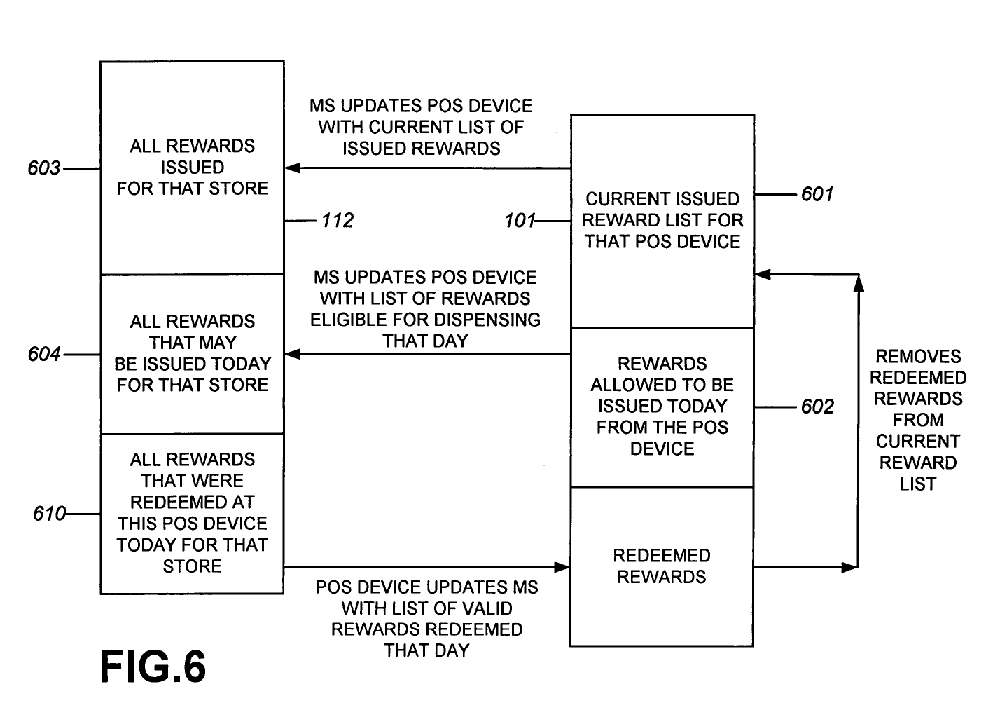

A modem auto answer application to interface with the POS device 112 is provided on MS 101 or TPS 102. The modem auto answer application listens for an incoming modem connection and, when connected, the application will query the POS device 112 for its identity by way of serial number and for its dispensed reward details and will update related reward details in the database. It will calculate and create a new set of rewards for the next business cycle if appropriate and will download a new set of reward dispensing rules and any other scheduled changes for the POS device 112 which may include the information set forth in FIG. 6 relating to the rewards already issued and potential rewards that may be issued on the date of download from MS 101 to POS 112. These functions are also conveniently illustrated in FIG. 5 which includes a possible table of interchanges between MS 101 and the POS device 112 (Table I), interchanges between the business establishment and the MS 101 (Table II), interchanges between the MS 101 and the sponsor (Table III), interchanges between the MS 101 and the reward table (Table IV) and interchanges between the MS 101 and the program table (Table V). The functions carried by the tables offer assistance to a systems programmer when organizing the software supporting the reward program and is intended to show only possible examples of how such tables may be prepared.

The connection between the MS 101 and the POS device 112 may be direct using communication ports or remotely by phone, fiber, wireless satellite or cable to a communication port on the POS device 112 or indirectly through the TPS 102.

When downloading information, MS 101 will download directly to one or more of the POS devices 112. The download may conveniently include a combination of reward and non-profit donation information. Such information might include, for example, discount percentages, dollar amounts redeemable, purchase prices and redeemable coupon, voucher and certificate values and the length of time each coupon, voucher or certificate is intended to be redeemable. Non-profit information downloaded will include minimum donation amounts, all information required to make such programs legal, and the necessary information for printing tax receipts. For certificates, which require a payment from the customer, the MS 101 and the POS device 112 will maintain records of these transactions and report the number of certificates issued and which may conveniently include identifiable identifiers to identify the certificates redeemed, the total dollar amounts which are relevant and the amounts owed to each party involved.

Reference is made to FIG. 6 which illustrates a general data download from MS 101 to POS 112 and a subsequent upload of data from POS 112 to MS 101.

MS 101 initially will carry information relating to currently issued coupons (CCL's) 601 and information relating to coupons to be issued (CIT's) 602 on a day of interest, namely for example, today. MS 101 will download information to POS 112, which information will include the coupons issued to that business establishment 603 and the coupons that may be issued today 604, such that the POS 112 will recognize, issue and redeem such coupons.

In due course, POS 112, having maintained data on the coupons redeemed at 610, will upload that data to MS 101 so that the redeemed coupons 610 can be removed from the list of CCL's 601 in subsequent downloads by MS 401. This technique prevents fraudulent redemption of coupons and also provides information on coupon redemption.

MS 101 will also download to TPS 102. This downloaded information is contemplated to include the combination of rewards by way of certificates, vouchers, tickets and coupons and non-profit donation information. Discount percentages, dollar amounts redeemable, purchase prices and redeemable coupons, vouchers and certificate values, where the coupon, voucher, ticket or certificate is redeemable and the length of time each coupon, voucher or certificate is redeemable. The downloaded non-profit information would include minimum donation amounts, information to make the program legal, and necessary information for printing tax receipts for the contributors. Instructions for the issuance of rewards or certificates to be issued by the POS device 112 for each desired period of time may also be obtained.

The connection between MS 101 and TPS 102 can be via phone line, fiber, wireless, satellite or cable to a communication port on the POS device 112 and the transfer of information to TPS 102 from MS 101 can be initiated by either the MS 101 or TPS 102. Once the MS 101 has acknowledged receipt of the downloaded information, the TPS 102 will allow its memory to be overwritten thereby contributing to reduced storage requirements.

The information received from the MS 101 by way of the POS device 112 or POS devices 112 may be downloaded from the TPS 102 to the POS device 112. Such information may conveniently include the rewards by way of certificates, vouchers or coupons, and non-profit donation information, such data including the similar information received from the MS 101 by the TPS 102. The transfer of information to TPS 102 can be initiated by POS device 112 or by the TPS 102. When TPS 102 has acknowledged receipt of the information to the POS device 112, the POS device 112 may conveniently allow the information on the POS device 112 to be overwritten thereby contributing to reduced storage requirements of the POS device 112.

### OPERATION

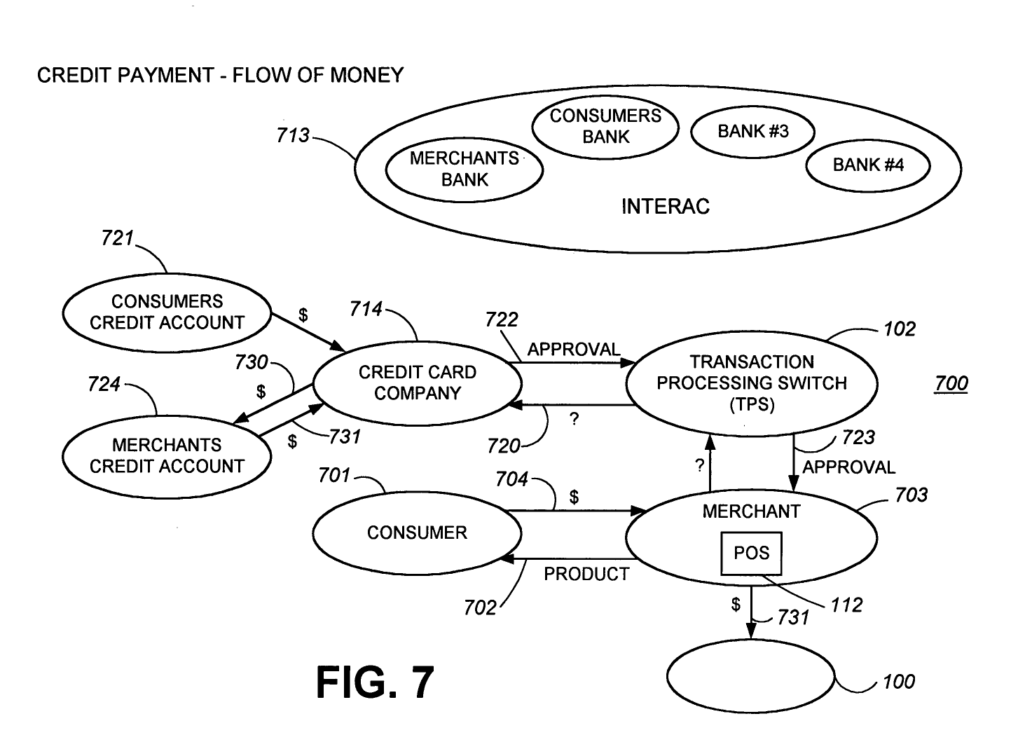

Referring to FIG. 7, a credit card transaction is generally shown at 700. The financial transaction 700 commences with a consumer 701 purchasing a product 702 from a merchant of a business establishment 703 with the use of a credit card which is represented by the transaction line 704. The credit card is “swiped” through a point of sale(POS) device 112 or data from the card is otherwise entered into the POS device 112, the device 112 being located at the cash register or other convenient check out location within the premises of the business establishment 703.

POS device 112 is connected with TPS 102 which has the ability to transmit financial information with various ones of the credit card companies, one of which is illustrated at 714, and various banks shown generally at 713 which, for example, are integrated and form part of a system known as the INTERAC system in Canada. In the present case, with the consumer 701 using a credit card which is represented by pathway 703, TPS 102 communicates with the credit card company 714 as represented by pathway 720. The credit card company 714, in turn, interrogates the credit account 721 of the consumer and, if the credit card limit is not exceeded and the account of the consumer is otherwise in good standing, the credit card company 714 will approve the transaction over pathway 722 to TPS 102 and then over the pathway 723 to the POS 112 in business establishment 703.

Simultaneously, funds will be transferred from the credit card company 714 to the credit account 724 of the business establishment 703 as represented by pathway 730.

There will be a charge associated with the transaction since POS device 112 is designed to function in other capacities for the benefit of the business establishment 703 and the consumer 701 as has been explained and as will be further explained. The charge is debited from the credit account 724 of the business establishment 703 by pathway 731 and that amount is then credited to the account of the supervisory control system 100 (FIG. 1) represented by pathway 731.

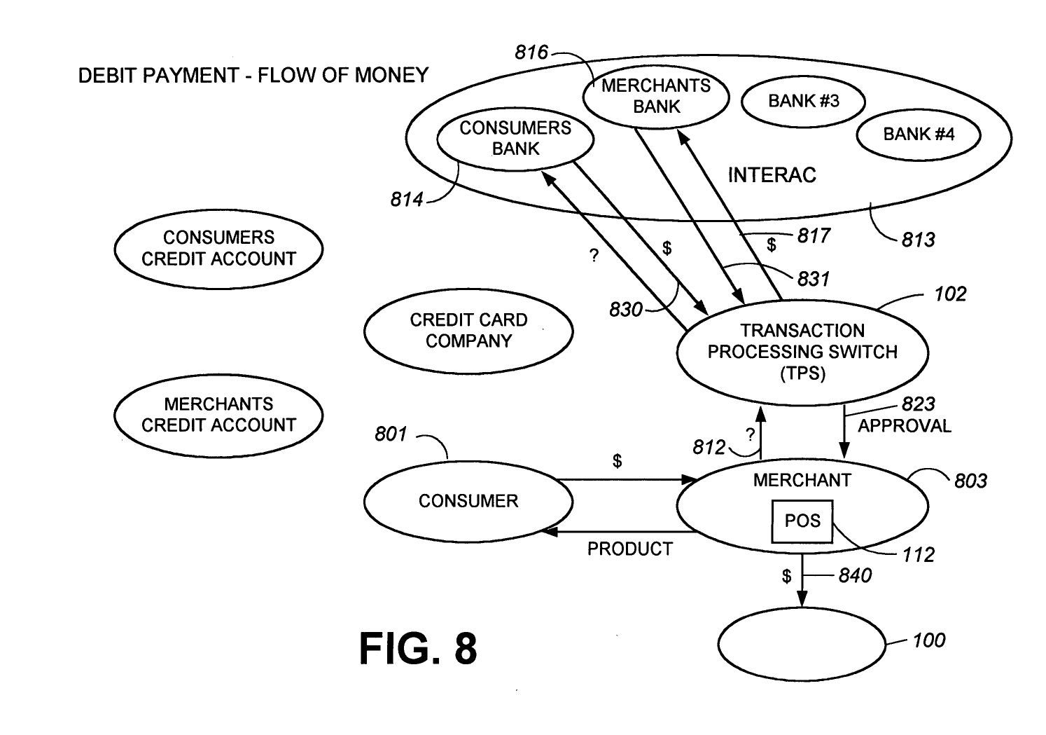

With reference now to FIG. 8, the financial transaction is quite similar to that described in FIG. 7 but the card used by the consumer 810 is a debit card issued by banks within the INTERAC system 813. The POS device 112 is precisely the same as the POS device 112 of FIG. 1 and the interrogated amount of the transaction will be transmitted to the TPS 102 over pathway 813. The POS device 112 is precisely the same as the POS device 112 of FIG. 1 and the interrogated amount of the transaction will be transmitted to TPS 102 over pathway 812. TPS 102 will, in turn, interrogate the appropriate bank 814 which carries the account of the consumer 801 and, if the transaction is in order, the bank 814 will transfer the funds, fist to TPS 102 by pathway 830 which funds will then be credited to the merchants bank 816 by pathway 817. Simultaneous approval of the transaction will be communicated to the business establishment 803 by pathway 823 and such approval will be displayed by POS device 112, There will be a charge associated with this transaction since the POS device 112 is specially designed to function in other capacities for the benefit of the business establishment 843 and the consumer 801 as previously explained. The charge is debited from the bank account 816 of the business establishment 803 via pathway 831 and is credited to the account of the supervisory control system 100 (FIG. 1).

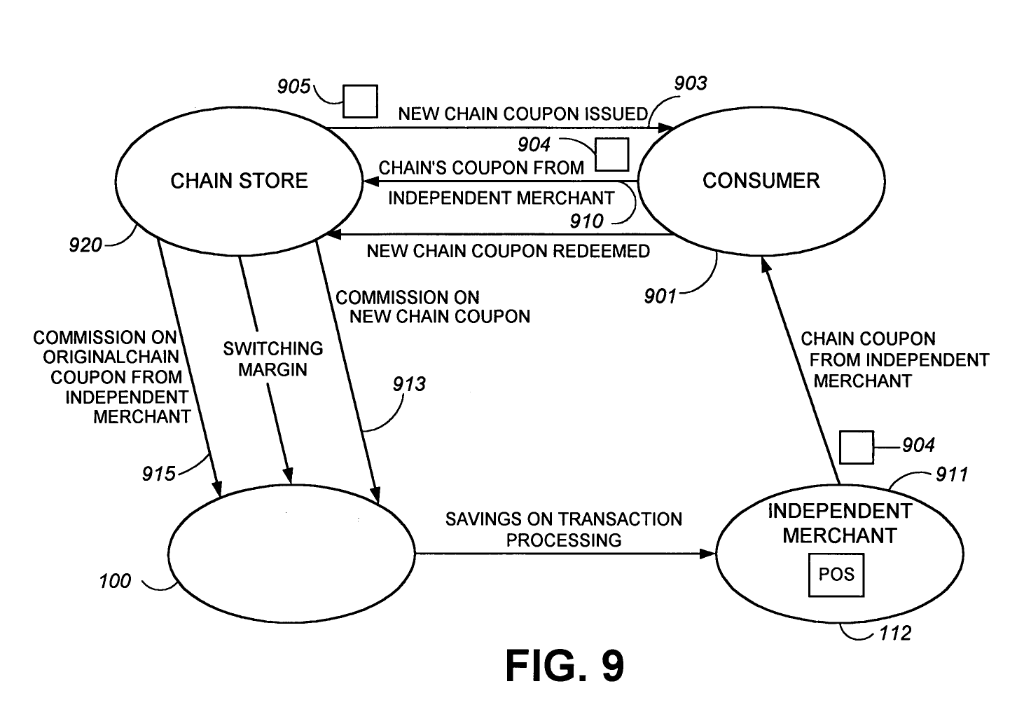

Reference is now made to FIG. 9 which illustrates the further usefulness of the POS device 112 which, in addition to interrogating the bank and credit card accounts of the consumer 701, 801 (FIGS. 7 and 8) and crediting the accounts of the business establishment 724, 816 described in relation to FIGS. 7 and 8, respectively, can also issue a reward for the consumer 901.

It will be assumed the consumer 901 is using either a debit or credit card as earlier described, although a cash transaction is intended to function as well, and that the transaction in both instances has been approved and indicated as being so approved on the POS device 112 in use at the “independent merchant” establishment location 911. This “independent merchant” 911 is intended to be a business establishment which may or may not have a plurality of other business locations and which may or may not have a variety of different departments or business units within the location where the POS device 112 described is being used. In any event, the anchor merchant 902 in the present embodiment is intended to be the business establishment which provides the benefit to the consumer 901 by way of the reward as has been described where the reward is redeemed.

The consumer 901 will complete an approved financial transaction by way of debit or credit card of by cash with the independent business establishment 911. The design of the POS device 112 according to the invention and to the supervisory control system 100 (FIG. 1), will allow a reward by way of voucher, certificate, ticket or coupon 904 to be printed and given to the consumer 901 as represented by pathway 912 because of the programming capabilities included in the POS device 112 according to the invention and the supervisory control system 100. The reward 904 represented by pathway 912 in FIG. 3 is conveniently referred to as a “migrating coupon” or an “independent merchant reward” 914 and may be for a discount or a prize or it may simply advise the consumer 901 that his purchases are subject to a percentage reduction in selling price of the goods located within the premises of the anchor business establishment 920 or of goods located at the business establishment of another merchant. In any event, the reward is not redeemable at the independent merchant 911.

The reward 904 issued to the consumer 901 may be of the type that gives the consumer 901 a discount on merchandise within a different department or business unit within the business establishment of the anchor tenant 920 thus encouraging the consumer to visit the business establishment of the anchor merchant 920. Alternatively, the reward could be redeemable at a different business establishment as seen in FIGS. 1, 2, 3 and 4. For example, it is known that store chains selling the same general goods in the various outlets may sell more upscale goods in upscale locations and less expensive goods at locations located elsewhere. The reward issued by the business establishment 911 (FIG. 9) could be redeemable at a location where less expensive goods are sold. The benefit to the redeeming business establishment 920 in this case is that excess inventory can be reduced and/or additional business generated at the redeeming business establishment 920 by the use of the reward. In any event, the consumer 901 will redeem the reward 904 obtained from the independent merchant 911 for the anchor merchant 920. At that point, a new coupon 905 could be issued to the consumer 902 as represented by pathway 903 and that reward 905 would be redeemable at the anchor merchant 920 as represented by pathway 901.

To enter into an arrangement with a third party or independent merchant 911 as shown in FIG. 9 and in return for an enhanced POS device 112 being located on the premises of the independent merchant 911, the transaction costs of the debit or credit card could conveniently be borne or reduced by the anchor merchant 920 within which the reward is redeemed. Otherwise, the independent merchant 911 could simply be paid a fee for each reward issued. The enhanced POS device 110 located at the independent merchant 911 would issue a reward 904 to the consumer 901 as represented by pathway 912 and the issued reward would be redeemable by the anchor merchant 920 as represented by pathway 910. The anchor merchant 920 would receive additional business which would otherwise be absent and the independent merchant 911 issuing the reward would receive reduced transaction costs, faster monetary credit or a fee when a consumer entered into a financial transaction at his location. The independent merchant 911 could also simply be paid for issuing rewards from the POS device 112 at his location by the redeeming or anchor merchant 920. And, in further consideration, since the use of debit cards is more attractive to merchants, a reward given solely for the use of cash or a debit card, might be useful and attractive to many merchants.

In any event, a charge will be made by the supervisory control system 100 (FIG. 1) for the issuance of the reward 904 to the consumer 901 as represented by pathway 912 and for the issuance of the reward 905 from an anchor merchant 920 to the consumer 901 as represented by pathway 903. The charges will be credited to the account of the supervisory control system 100 as represented by pathways 913, 915. A further charge may be made against the anchor merchant 920 and credited to the account of the supervisory control system 100 as represented by pathway 914. This charge is due to enhanced revenue which benefits the anchor merchant 920.

In a further embodiment of the invention, and with reference to FIG. 1, it may be desirable to maintain a data base of cash, credit and debit card use within the business establishment 103 where a POS device 112 is being used. This data base could be used to establish a “loyalty program” by issuing cards, convenient SMART or RF identification cards, to consumers and eliminating the expensive necessity of maintaining account information by the use of software and support. A loyalty program is usually reserved only for the largest chain establishments since the setup and continuing support costs are a monetary burden. Such a data base could be maintained by the supervisory control system 100 with or without additional costs to the subscribing business establishments.

Yet a further embodiment of the invention relates to the situation where RF r/w identification cards are issued by the supervisory control system 100. These RF identification cards are intended to convey user information to a suitable receiving device by way of wireless or RF transmission. Such cards are also able to receive wireless or RF transmissions which can write appropriate reward information on the RF card. Thus, a consumer could enter a subscribing business establishment while possessing an RF identification card and the card reader or other receiving device would conveniently download financial information and the identity of the card holder from the card by way of wireless or RF communication. In the event the financial and identity information of the card holder was of the type desirable to the merchant where the receiving device was located, the card holder could be issued a reward from a printing device or from the enhanced POS device 112 without the necessity of entering into a financial transaction or swiping a card through the reward dispensing or POS device at the business establishment.

Many further embodiments of the invention may readily be envisioned by those skilled in the art to which the invention relates and the specific embodiments described should be taken as illustrative of the invention only and not as limiting its scope as defined in accordance with the accompanying claims.

1. Control and acquisition system for automated advertising of a first business establishment, said system comprising a master station (MS), a transaction processing switch (TPS), at least one point of sale (POS) device located at said business establishment and supervisory software allowing communication between said MS, said TPS and said POS device, said POS device generating a reward to a user interacting with said POS device.

2. System as in claim 1 wherein said reward includes a voucher, a certificate, a ticket or a coupon redeemable at said business establishment.

3. System as in claim 1 wherein said reward is usable at a second business establishment.

4. System as in claim 2 wherein said MS holds data relevant to said reward information.

5. System as in claim 4 wherein said data includes the number of coupons, vouchers, tickets or certificates to be generated by said POS device.

6. System as in claim 4 wherein said voucher, coupon, ticket or certificate are generated by printing, displaying, audibly issuing or transmitting.

7. System as in claim 4 wherein said voucher, coupon, ticket or certificate information are transmitted to a storage device carried by said user.

8. System as in claim 7 wherein said storage device includes a magnetic card, a chip card, an RF identification car or a holographic card.

9. System as in claim 1 and further including a transfer means to transfer funds to the account of a third party not involved in said financial transaction.

10. Control and acquisition system as in claim 1 wherein said reward is generated at the completion of a financial transaction between said user and said first business establishment.

11. Control and acquisition system as in claim 1 wherein said reward is generated without the completion of a financial transaction between said user and said business establishment.

12. Control and acquisition system as in claim 1 wherein said user interacts with said POS device with a data storage device.

13. Control and acquisition system as in claim 1 wherein said data storage device is a debit or credit card.

14. Control and acquisition system as in claim 8 wherein said magnetic card is a magnetic stripe card.

15. Supervisory control system as in claim 1 and further including more than one point of sale (POS) device, said devices being located at different business establishments.

16. Method of issuing a reward to a user participating in a financial transaction at a first business establishment and using a debit or credit card, said method including verifying information concerning said transaction and said debit or credit card, transferring funds between said account of said user and said business establishment using said debit or credit card and issuing said reward to said user following said verification of said information concerning said financial transaction and said debit or credit card.

17. Method as in claim 16 wherein said reward is a voucher, coupon, ticket or certificate, said reward being redeemable at said first business establishment.

18. Method as in claim 16 wherein said reward is redeemable at a second business establishment.

19. Method as in claim 16 wherein said reward is in the form of a ticket, a voucher, a coupon, a certificate, an aural generation or a visual display.

20. Method of advertising using a point of sale(POS) processing device, said method comprising providing display and reward instructions to said processing device, allowing a user to provide information to said processing device in a financial transaction, obtaining financial information on said user to verify said financial transaction may be completed and issuing a reward to said user in accordance with said display and reward instructions.

21. Wireless card reader device to read personalized information of a user and means to issue a reward to said user following said reading of said information.

22. Supervisory control and acquisition system for a first business establishment, said system comprising a programmable point of sale (POS) device located at said first business establishment, said programmable point of sale (POS) device being controlled by a processing unit communicating with said point of sale (POS) device from a location remote from said point of sale (POS) device, said programmable point of sale (POS) device being adapted to conduct credit and debit card transactions with a user and to provide a consumer with a reward at said first business establishment.

23. Supervisory control and acquisition system as in claim 22 wherein said reward is a certificate, voucher, ticket or coupon which is printed from said point of sale (POS) device.

24. Supervisory control and acquisition system as in claim 22 wherein said reward transmitted from said point of sale (POS) device.

25. Supervisory control and acquisition system as in claim 23 wherein said reward is redeemable at said first business establishment.

26. Supervisory control and acquisition system as in claim 25 wherein said reward is redeemable at a second business establishment.

27. Supervisory control and acquisition system as in claim 24 wherein said reward is transmitted to a storage device carried by said consumer.

28. Supervisory control and acquisition system as in claim 27 wherein said storage device is a debit/information storage device.

29. Supervisory control and acquisition system as in claim 28 wherein said data/information storage device is a magnetic strip, a chip, an RF identification or a holographic card.

30. Supervisory control and acquisition system as in claim 22 wherein said reward is transmitted wirelessly to a card wirelessly receiving said reward.

31. Method of supervising an advertising and reward system carried out within a business establishment comprising the steps of programming at least one point of sale (POS) device located at a business establishment from a controller located remotely from said point of sale (POS) device, said programming containing instructions relating to said advertising and reward system, sensing a financial transaction occurring on said point of sale (POS) device with a consumer, determining whether said customer is eligible for receiving a reward and issuing said reward to said consumer if said consumer is eligible for said reward.

32. Method of supervising as in claim 31 wherein said consumer is instructed that said reward is redeemable only at said business establishment.

33. Method of supervising as in claim 31 wherein said consumer is instructed that said reward is redeemable only at a second business establishment.

34. Method of supervising as in claim 31 wherein said reward is issued to said consumer by transmission to a data storage device carried by said consumer.

35. Method of supervising as in claim 31 wherein said reward is wirelessly issued to a card carried by said consumer, said card being operable to receive said wirelessly transmitted reward.

36. Method of supervising as in claim 31 and further comprising programming a second point of sale (POS) device located at said business establishment.

37. Method of supervising as in claim 35 wherein said card is a magnetic strip, a chip, an RF identification or a holographic card.

38. Supervisory control system for an automatic reward and advertising system intended for business establishments, said system comprising at least one point of sale (POS) card reader to read the card of a user and to dispense a reward to said user, a controller to program said point of sale (POS) device and to download data to and upload data from said point of sale (POS) device at predetermined intervals, said point of sale (POS) device generating a reward to said user wherein said user may redeem said reward at a business establishment having a location where said point of sale (POS) device is located.

39. Supervisory control system as in claim 38 wherein said reward generated to said user is one of a plurality of rewards displayed by said P:OS device, said user selecting said reward from said displayed rewards.

40. Supervisory control system as in claim 39 wherein said plurality of displayed rewards are displayed on said POS device.

41. Supervisory control system as in claim 39 wherein said plurality of displayed rewards are displayed on hard copy generated by said POS device.
